(19) United States
(12) Patent Application Publication
(10) Pub. No.: US 2012/0127246 A1
(43) Pub. Date: May 24, 2012

(54) Ink cartridge structure

(76) Inventor: CHI-CHANG LIU, Chungli City (TW)

(21) Appl. No.: 12/949,027

(22) Filed: Nov. 18, 2010

(51) Int. Cl. B41J 2/175

(52) U.S. Cl. 347/86

(57) ABSTRACT

An improved ink cartridge structure comprises a cartridge body, and a first panel and a second panel disposed to two sides of the cartridge body to seal the cartridge body. An ink throttle layer is disposed in the cartridge body. A containing tank is formed at a side of the ink throttle layer. An ink supply passage having bend channels is disposed to another side of the ink throttle layer. An ink inlet is disposed to an end of the ink supply passage. The ink inlet has two air holes that communicate with the containing tank. Another end of the ink supply passage is engaged with a filter port. The filter port is engaged with an ink outlet storing chamber. The ink outlet storing chamber is connected to an ink outlet. With the ink supply passage and the two air holes, pressure can be reduced, and ink flow can be regulated.

### BACKGROUND OF THE INVENTION

1. Field of the Invention

The present invention relates to an improved ink cartridge structure, and more particularly to an ink cartridge having an ink throttle structure.

2. Description of the Related Art

In a mass of computer peripheral equipment, a printer almost becomes one of computer peripheral equipment in widespread use. When an ink-jet printer performs printing, the related transmission mechanism drives an ink cartridge to spray ink on a paper medium. Ink is a consumable and can be stored in the ink cartridge through design. The empty ink cartridge can be conveniently replaced with new one by a user when ink within the ink cartridge is used up.

Since the price of the ink-jet printer is lower than a laser printer, the ink-jet printer is accepted by families. Moreover, since the market competition of the ink-jet printer is quite intense, each printer company gradually changes its marketing strategy. After the printer is sold to consumer, the printer company can easily charge expenses of consumables such as ink cartridges. The price of these ink cartridges is sometimes higher than the printer.

Presently, ink cartridges in the market are usually one-time used ink cartridge. In another word, when ink within the ink cartridge is completely used up, the ink cartridge may not be continuously utilized by filling ink, and the whole set of ink cartridge must be replaced. However, a common ink-jet printed equipped with the ink cartridge may be for sale at $30 to $40 dollars. If a consumer would like to replace a new ink cartridge produced from dealers, the price may be at $25 to $30 dollars that is almost equal to the price of the ink-jet printer.

In addition, the conventional ink cartridge further has the following defects:

1. Ink may not be smoothly filtered, resulting in blocking an ink outlet.

2. Ink supply passages are not many and not designed well to accumulate ink at an ink outlet.

3. While refilling ink, 15 percent of residual ink existing in the ink supply passage must be pumped and is unable to supply to the printer, resulting in wasting materials and inconvenience

The foregoing problems cause a serious issue and need to be overcome through redesign.

### SUMMARY OF THE INVENTION

In view of the shortcomings of the prior art, the inventor(s) of the present invention based on years of experience in the related industry to conduct extensive researches and experiments, and finally developed an ink cartridge having an ink throttle structure capable of regulating ink flow quantity and temporarily storing fewer ink through an ink outlet storing chamber, thereby preventing ink supply from being discontinued.

To achieve the foregoing objective, an improved ink cartridge structure provided by the invention comprises a cartridge body, wherein two sides of the cartridge body are sealed by a first panel and a second panel. An ink throttle layer is disposed in the cartridge body. The cartridge body has a containing tank formed at a side of the ink throttle layer. Another side of the ink throttle layer has an ink supply passage having bend channels.

An ink inlet is disposed to an end of the ink supply passage. The ink inlet has two air holes that communicate with the containing tank. With the ink supply passage having the bend channels and the two air holes, pressure can be reduced, and ink inflow quantity can be regulated.

A filter port is engaged with another end of the ink supply passage. The filter port is engaged with an ink outlet storing chamber. The ink outlet storing chamber is connected to an ink outlet. The ink outlet storing chamber temporarily stores fewer ink to prevent ink supply from being discontinued.

The containing tank communicates with a ventilation channel that communicates with a ventilation bore. When ink is provided, ink within the containing tank achieves pressure steady through the ventilation channel communicating with the ventilation bore.

### BRIEF DESCRIPTION OF THE DRAWINGS

FIG. 1 is a cross-sectional drawing of an improved ink cartridge structure according to the present invention;

FIG. 2 is a schematic diagram of a cartridge body of an improved ink cartridge structure according to the present invention;

FIG. 3 is a decomposition drawing of an improved ink cartridge structure according to the present invention;

FIG. 4 is a schematic diagram of an ink movement of an improved ink cartridge structure according to the present invention;

FIG. 5 is another schematic diagram of an ink movement of an improved ink cartridge structure according to a third embodiment of the present invention; and

FIG. 6 is another decomposition drawing of an improved ink cartridge structure according to the present invention.

### DETAILED DESCRIPTION OF THE PREFERRED EMBODIMENTS

The foregoing and other technical characteristics of the present invention will become apparent with the detailed description of the preferred embodiments and the illustration of the related drawings.

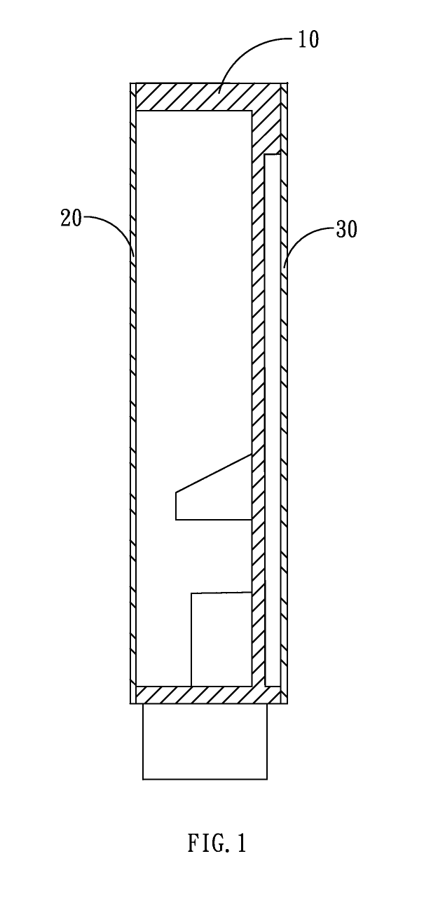

The objective of the invention is to provide an ink cartridge structure ensuring the supply quality of ink. As shown in FIG. 1, the whole ink cartridge is basically composed of a cartridge body 10, a first panel 20 and a second panel 30. Ink for printing can be contained inside the ink cartridge.

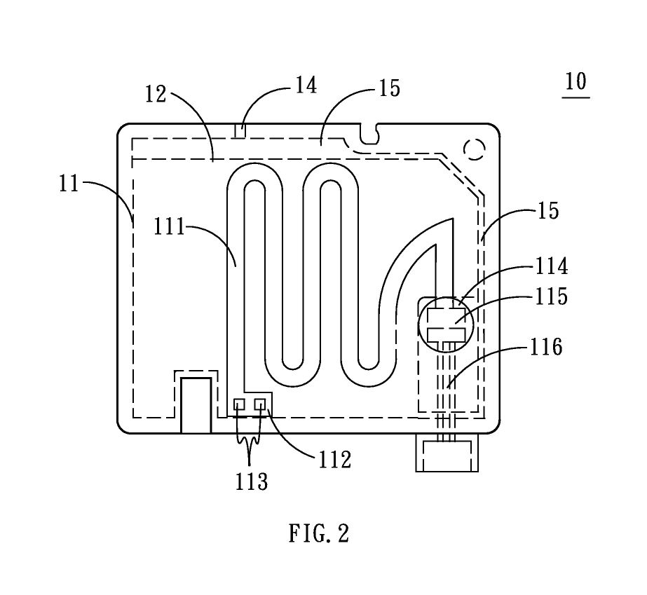

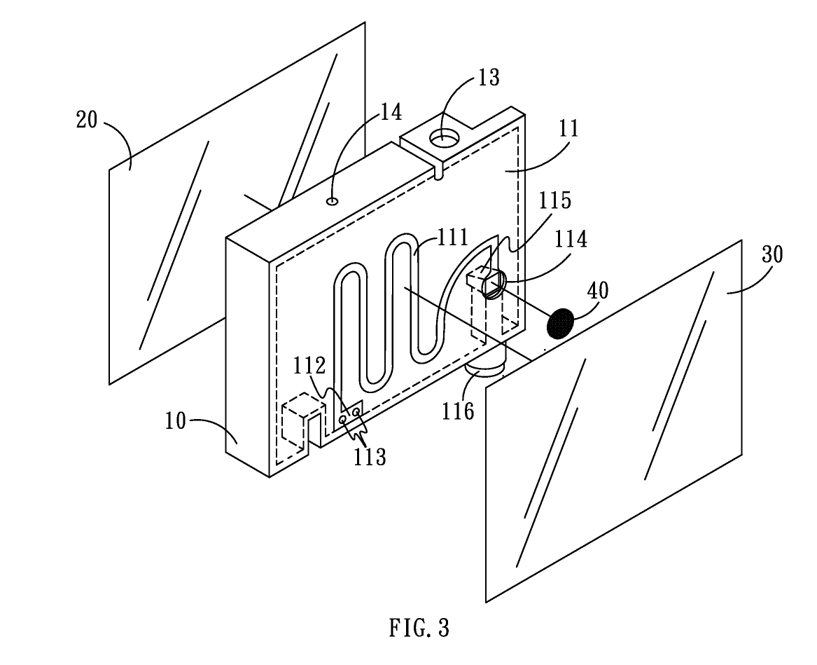

With reference to FIG. 2 and FIG. 3, the cartridge body 10 has an ink throttle layer 11. The cartridge body 10 has a containing tank 12 having a containing space formed at a side of the ink throttle layer 11. The cartridge body 10 is partitioned by the ink throttle layer 11 into the containing tank 12 and an ink supply passage 111.

The containing tank 12 contains ink, and the ink supply passage 111 is disposed to another side of the ink throttle layer 11. The ink supply passage is composed of a plurality of bend channels. One end of the ink supply passage 111 is engaged with an ink inlet 112. The ink inlet 112 communicates with the containing tank 12. Further, the ink inlet 112 has two air holes 113. Ink contained in the containing tank 12 can flow into the ink supply passage 111 through the ink inlet 112. Pressure can be reduced, and ink flow can be regulated by utilizing the ink supply passage 111 having bend channels and the two air holes 113.

Another opening of the ink supply passage 111 is engaged with a filter port 114. The filter port 114 is engaged with an ink outlet storing chamber 115. An ink outlet 116 is connected to the ink outlet storing chamber 115. The ink outlet 116 further protrudes the cartridge body 10. The ink outlet storing chamber 115 temporarily stores fewer ink to prevent ink supply from being discontinued.

Moreover, the containing tank 12 communicates with a ventilation channel 15. A ventilation bore 14 communicates with the ventilation channel 15. When ink outflows, ink within the containing tank 12 communicates with the ventilation bore 14 through the ventilation channel 15 to immediately supply exterior air into the containing tank 12 so that the pressure inside the containing tank 12 can be steadied to retain the same air pressure as well as outside.

A first panel 20 corresponds to the containing tank 12 and covers a side of the cartridge body 10. In addition, a second panel 30 corresponds to the ink throttle layer 11 and is pasted to another side of the cartridge body 10. The first panel 20 and the second panel 30 in the embodiment are plastic films. Since the first panel 20 and the second panel 30 are respectively glued to the two sides of the cartridge body 10 so that the ink cartridge is sealed.

Further, an ink refill opening 13 is disposed on the cartridge body 10. The ink refill opening 13 communicates with the containing tank 12 so that ink can be filled into the cartridge body 10 through the ink refill opening 13. In addition, a filtering member 40 is disposed to the filter port 114. The filtering member 40 can be a filter net piece for filtering ink and regulating ink flow.

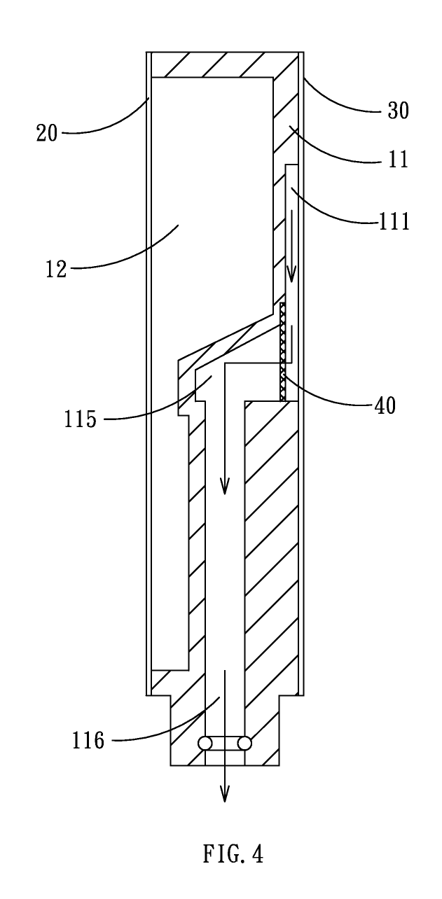

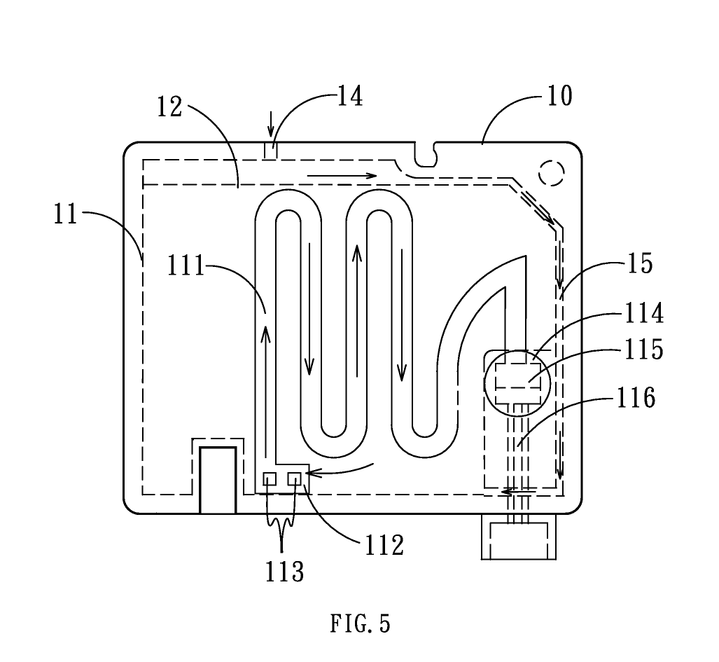

Ink flow shown in the invention is clearly depicted herein. With reference to FIG. 4 and FIG. 5, the containing tank 12 of the ink cartridge contains ink. The ink inlet 112 is located at a bottom of the containing tank 12 to allow ink flowing into the ink supply passage 111 through the ink inlet 112. Ink then passes through the filtering member 40. By utilizing the ink supply passage 111 and two tiny air holes 113, pressures can be reduced, and ink flow can be regulated to prevent ink from flowing in mass, resulting in accumulating ink. Impurities within ink then are filtered by the filtering member 40 inside the filter port 114. The demand of outputting a great quantity of ink for printing can be instantly provided through the ink outlet storing chamber 115 capable of temporarily storing ink so that when ink is outputted from the ink outlet 116, it may cause blocking-up and prevent ink supply from being discontinued. Simultaneously, ink within the containing tank 12 can communicate with the ventilation bore 14 through the ventilation channel 15 to achieve pressure steady so that ink within the containing tank 12 can adequately outflow without remaining ink therein.

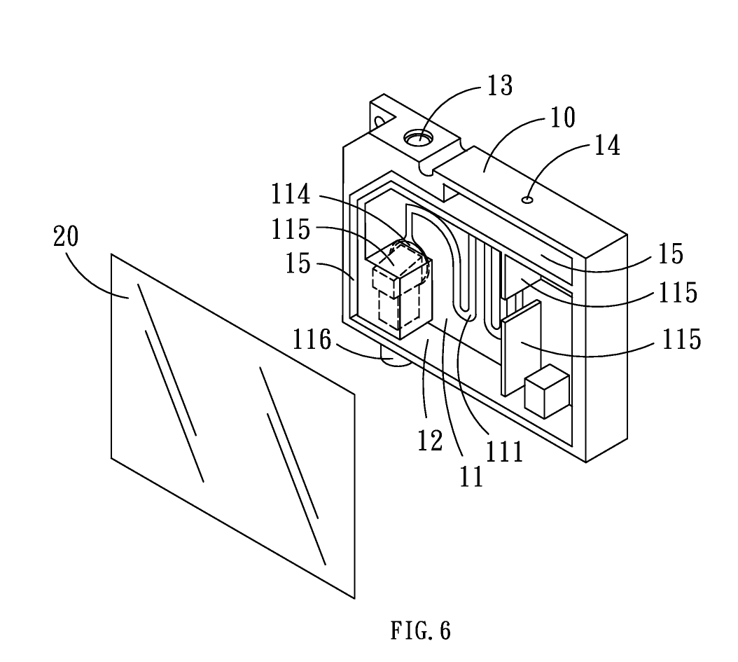

In addition, as shown in FIG. 6, the ink throttle layer 11 has a plurality of rib plates 117 extended from a side of the containing tank 12. When ink flows through intervals between rib plates 117, ink flow can be indirectly controlled, and ink flowing and the steady of ink flow quantity can be further enhanced.

The ink cartridge provided by the invention is that the ink supply passage 111 incorporates with the two air holes 112 through the inner improved structure of the cartridge body 10. The ventilation channel 15 is disposed and communicates with the ventilation bore 14. Moreover, by installing the filter port 114, the filtering member 40 and the plurality of rib plates 117, the invention does not only provide ink supply effect at high quality, but also reduce production and manufacturing cost.

The improved ink cartridge structure improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. An improved ink cartridge structure comprising:
a cartridge body having an ink throttle layer therein, the cartridge body having a containing tank formed at a side of the ink throttle layer, another side of the ink throttle layer having an ink supply passage that has bend channels, wherein the containing tank communicates with a ventilation channel, and the ventilation channel communicates with a ventilation bore, and one end of the ink supply passage is provided with an ink inlet, and the ink inlet communicates with the containing tank, and the ink inlet has two air holes, and another end of the ink supply passage is engaged with a filter port, and the filter port is engaged with an ink outlet storing chamber, and the ink outlet storing chamber is connected to an ink outlet;
a first panel corresponding to the containing tank and pasted to a side of the cartridge body; and
a second panel corresponding to the ink throttle layer and pasted to another side of the cartridge body.

2. The improved ink cartridge structure as recited in claim 1, wherein the ink supply passage has a plurality of bend channels.

3. The improved ink cartridge structure as recited in claim 1, further comprising a filtering member that is disposed in the filter port.

4. The improved ink cartridge structure as recited in claim 1, wherein the cartridge body has an ink refill opening, and the ink refill opening mutually communicates with the containing tank.

5. The improved ink cartridge structure as recited in claim 1, wherein the first panel is a plastic film.

6. The improved ink cartridge structure as recited in claim 1, wherein the second panel is a plastic film.

7. The improved ink cartridge structure as recited in claim 1, wherein the first panel and the second panel seal the cartridge body.

8. The improved ink cartridge structure as recited in claim 1, wherein the ink throttle layer has a plurality of rib plates extended from a side of the containing tank.
